(19) United States
(12) Patent Application Publication
(10) Pub. No.: US 2024/0279554 A1
(43) Pub. Date: Aug. 22, 2024

(54) Methods and Systems Utilizing Methane Pyrolysis Integrated with Carbon Dioxide Conversion for Producing Low-carbon Intensity Fuels

(71) Applicant: Chevron U.S.A. Inc., San Ramon, CA (US)

(72) Inventors: WILLIAM BOORUJY, San Ramon, CA (US); CESAR OVALLES, San Ramon, CA (US)

(73) Assignee: Chevron U.S.A. Inc., San Ramon, CA (US)

(21) Appl. No.: 18/411,295

(22) Filed: Jan. 12, 2024

Related U.S. Application Data
(60) Provisional application No. 63/447,509, filed on Feb. 22, 2023.

(51) Int. Cl. C10G 2/00; B01D 53/62; B01D 53/73; C01B 3/24

(52) U.S. Cl. CPC C10G 2/50; B01D 53/62; B01D 53/73; C01B 3/24; B01D 2257/504; B01D 2258/0283; B01D 2258/06; C01B 2203/0272; C01B 2203/0277; C01B 2203/062; C01B 2203/1241; C01B 2203/80; C10G 2300/4043; C10G 2300/4081; C10G 2300/42; C10G 2400/02; C10G 2400/04; C10G 2400/08

(57) ABSTRACT

A process is provided that includes pyrolyzing methane to form a stream of hydrogen and solid carbon and co-feeding a CO₂-containing stream and the stream of hydrogen to a fuel synthesis unit in which the CO₂ of the CO₂-containing stream and the hydrogen of the stream of hydrogen are converted to a low-carbon intensity fuel. Also provided is a system comprising a pyrolizer for pyrolyzing methane having a methane inlet, an outlet for a stream of hydrogen, and an outlet for solid carbon. The system also comprises a fuel synthesis unit capable of receiving the stream of hydrogen and a CO₂-containing stream in which the CO₂ of the CO₂-containing stream and the hydrogen of the stream of hydrogen are converted to a low-carbon intensity fuel.

### CROSS REFERENCE TO RELATED APPLICATIONS

This application claims priority to U.S. Provisional Application Ser. No. 63/447,509 filed Feb. 22, 2023, the complete disclosure of which is incorporated herein by reference in its entirety.

### FIELD

This disclosure relates generally to methods and systems to produce low-carbon intensity fuels. More specifically, the methods and systems utilize methane pyrolysis integrated with carbon dioxide conversion.

### BACKGROUND

Only a small fraction of the global carbon dioxide (CO₂) emitted into the atmosphere is currently captured and utilized. There is an increasing interest in scalable, economic CO₂ conversion processes to reduce greenhouse gases (GHG) in the atmosphere while generating high-value commodity products such as fuels containing hydrogen and carbon. Such fuels are low-carbon intensity (CI) as they reduce the level of CO₂ in the atmosphere compared with conventional fossil-based fuels.

When renewable electricity, e.g., generated by wind or solar, is used to split water into oxygen and hydrogen in an electrolyzer, the hydrogen is referred to as green H₂. Green H₂ has low CI as no carbon is released in its production. Green H₂ can be used in the production of low CI hydrocarbons. For example, a prior art process flow diagram to produce liquid fuels from CO₂ and green H₂ from U.S. Patent Publication No. 2022/0251455 is shown in FIG. 1. Hydrogen produced by electrolysis 101 and captured CO₂ 102 are blended and heated 103 before entering the catalytic conversion system 104. After product separation 108, liquid fuels are generated for various applications. The process shown, however, suffers from several disadvantages. For instance, the use of an electrolyzer leads to significant cost in terms of Capital (CAPEX) and Operating (OPEX) expenses, especially using renewable electricity. The reliability of electrolyzer units has not been demonstrated in commercial use, e.g., use over 10 years. There is limited experience operating this type of unit in industrial environments, especially in refinery facilities. The electrolyzer membranes and electrodes used in this type of unit have a relatively short lifespan making them susceptible to degradation and failures. Water quality must be tightly controlled due to ion deposition that can poison the electrolyzer electrodes. Finally, pure oxygen generated in the electrolyzer anode requires special handling due to safety hazards.

Other processes have also emerged to generate low CI hydrogen to produce sustainable fuels. Methane (CH₄) pyrolysis is a valid alternative because the thermal decomposition of CH₄ gives rise to hydrogen and solid carbon. Thus, no renewable (green) electricity is needed. No electrolyzer is needed. As reported by Sánchez-Bastardo, N., et al. in Ind. Eng. Chem. Res. 2021, 60, 11855-11881 (https://doi.org/10.1021/acs.iecr.1c01679), two possible reactor configurations for methane pyrolysis are offered. These two configurations are shown in FIGS. 2A and 2B (prior art).

In FIG. 2A, natural gas is introduced at the bottom of a fluidized bed reactor 201 containing carbon catalyst particles. The outlet gas, composed of unconverted methane and hydrogen, is passed through a cyclone 202 to remove the possible entrained carbon particles. The gaseous product stream next flows through a membrane 203 to separate the methane and hydrogen. The recovered methane is recycled and co-fed to the reactor with a fresh, natural gas stream. The carbon catalyst and carbon deposits are collected at the reactor bottom, cooled in cooler 204, and stored. A small part of the carbon product can be introduced into the reactor after catalyst grinding 206 and/or reactivation via a regeneration method 205.

In FIG. 2B, another possible configuration is shown using two parallel reactors 201A and 201B. The reactors operate in a cyclic mode by alternately switching the natural gas feed and the regeneration agent stream (air, steam) between the two reactors. Methane pyrolysis occurs in the first reactor 201A, while the catalyst in the second reactor 201B is regenerated. After a specific time, once the catalyst in reactor 201A becomes spent, natural gas is fed into the second reactor 201B, where pyrolysis occurs over a regenerated catalyst, and the regeneration agent is introduced in the first reactor 201A to recover the activity of the corresponding spent catalyst. Despite the promising results obtained after catalyst reactivation, the regeneration techniques result in undesirable CO₂ emissions.

The reactor configurations shown in FIGS. 2A and 2B require very high temperatures (e.g., 800-1000° C.) to achieve the desired H₂ conversion levels (see Msheik, M., et al., Energies 2021, 14, 3107 (https://doi.org/10.3390/en14113107)). This temperature range is generally obtained by combusting natural gas, which leads to undesirable CO₂ emissions, increasing the CI of the produced hydrogen.

It would be desirable to have a process and system that would produce low CI fuels while avoiding the problems described above. Avoiding the use of an electrolyzer and avoiding undesirable CO₂ emissions would greatly enhance the desirability of a process for producing low-carbon intensity fuels.

### SUMMARY

Provided is a process and system to produce low CI fuels. The process and system accomplish the production by integrating methane pyrolysis with carbon dioxide conversion. In one embodiment, provided is a process that includes pyrolyzing methane to form a stream of hydrogen and solid carbon. The stream of hydrogen and a CO₂-containing stream are co-fed to a fuel synthesis unit in which the CO₂ of the CO₂-containing stream and the hydrogen of the stream of hydrogen are converted to a low-carbon intensity fuel.

In another embodiment, provided is a system comprising a pyrolizer for pyrolyzing methane. The unit has a methane inlet, an outlet for a stream of hydrogen, and an outlet for solid carbon. The system also comprises a fuel synthesis unit capable of receiving the stream of hydrogen and a CO₂-containing stream, in which unit the CO₂ of the CO₂-containing stream and the hydrogen of the stream of hydrogen are converted to a low-carbon intensity fuel.

Among other factors, the present process and system prepare low-carbon intensity fuels in an economical manner while reducing GHG emissions. The integration of methane pyrolysis to prepare CI hydrogen with a fuel synthesis unit for converting CO₂ and the hydrogen to low-carbon intensity fuels, permits total CO₂ capture while avoiding the problems inherent in an electrolyzer. As such, low, high quality, CI fuels are achieved economically.

### BRIEF DESCRIPTION OF THE DRAWINGS

FIG. 1 shows a flow diagram of a prior art process for the production of liquid fuels from CO₂ and H₂.

FIG. 2A shows a prior art reactor configuration for methane pyrolysis using a fluidized-bed reactor with a catalyst regeneration unit.

FIG. 2B shows a prior art reactor configuration for methane pyrolysis employing parallel reactors operating in a cycle reaction-regeneration mode.

FIG. 3 shows a process flow diagram for one embodiment of the present process in which low CI naphtha, jet fuel and diesel are produced by integrating methane pyrolysis and carbon dioxide hydrogenation.

FIG. 4 shows a process flow diagram for one embodiment of the present process in which low CI naphtha, jet fuel and diesel are produced by integrating methane pyrolysis and Fischer-Tropsch Synthesis.

FIG. 5 shows a process flow diagram for one embodiment of the present process in which low CI methanol and gasoline are produced.

FIG. 6 shows a process similar to that depicted in FIG. 3 integrating methane pyrolysis and direct CO₂ hydrogenation, except with Direct Air Capture as an additional CO₂ source.

FIG. 7 shows a process similar to that depicted in FIG. 4, integrating methane pyrolysis and Fischer-Tropsch Synthesis, except with Direct Air Capture as an additional CO₂ source.

FIG. 8 shows a process flow diagram of one embodiment similar to that depicted in FIG. 5, except that Direct Air Capture is an additional source of CO₂.

FIG. 9 shows a process flow diagram for one embodiment of the present process similar to that depicted in FIG. 3, except that only a CO₂-containing industrial stream is the source of CO₂.

FIG. 10 shows a process flow diagram for one embodiment of the present process similar to that depicted in FIG. 4, except that only a CO₂-containing industrial stream is the source of CO₂.

FIG. 11 shows a process with multiple possible sources of CO₂, including the flue gas from methane pyrolysis, a CO₂-containing industrial steam and Direct Air Capture.

FIG. 12 shows a process similar to that depicted in FIG. 5, except with multiple possible sources of CO₂, including the flue gas from methane pyrolysis, a CO₂-containing industrial steam and Direct Air Capture.

FIG. 13 shows a numerical process simulation of the integrated direct CO₂ hydrogenation with methane pyrolysis and CO₂ capture.

FIG. 14 includes Table 1 summarizing the stream properties and compositions obtained from the numerical simulation of the integrated direct CO₂ hydrogenation with methane pyrolysis and CO₂ capture as shown in FIG. 13.

FIG. 15 shows a numerical process simulation of the integrated Fischer-Tropsch synthesis with methane pyrolysis and CO₂ capture.

FIG. 16 includes Table 2 summarizing stream properties and compositions obtained from the numerical simulation of the integrated Fischer-Tropsch Synthesis with methane pyrolysis and CO₂ capture as shown in FIG. 15.

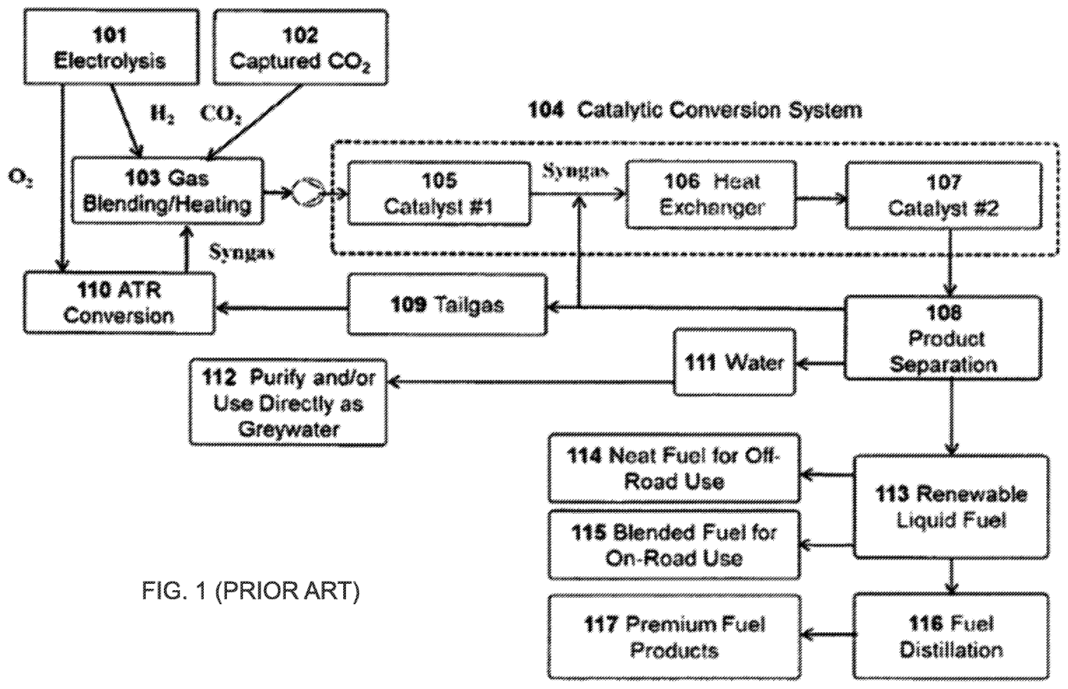

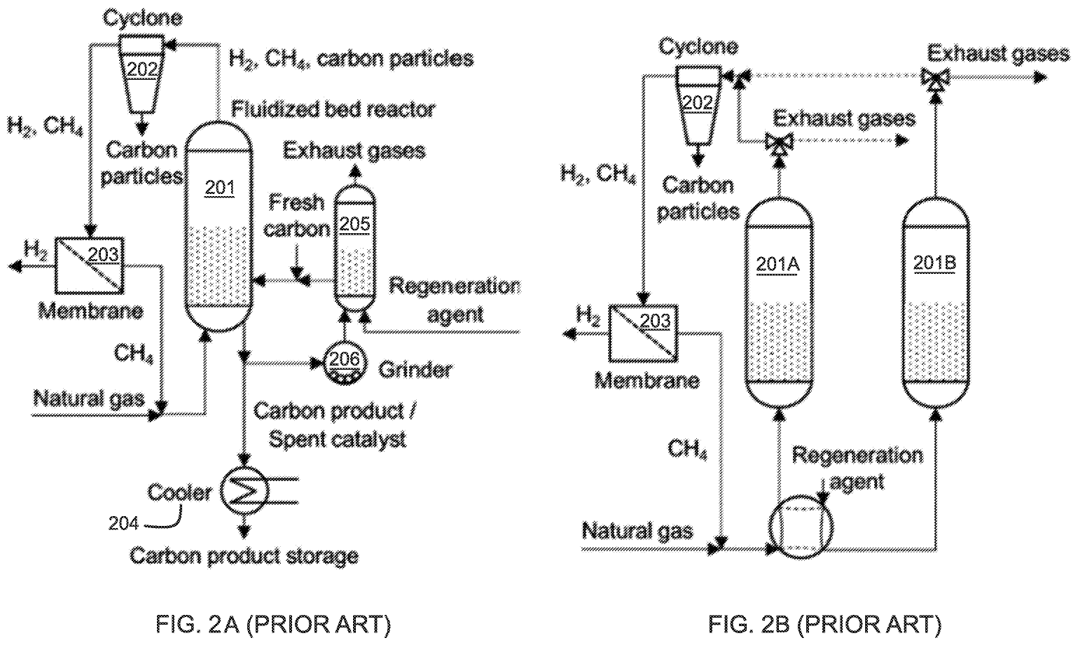

### DETAILED DESCRIPTION

Glossary: The term “jet-range hydrocarbons” refers to any hydrocarbon or hydrocarbon mixture that distills in the range from about 120° C. to about 300° C. and typically includes hydrocarbons with a carbon number between about C8 and about C16.

The term “jet fuel” refers to a mixture typically comprising primarily hydrocarbon compounds that can be used to operate a jet engine. Jet fuel can also include optional non-hydrocarbon additives. In practical terms, the mixture of hydrocarbons and optional additives called jet fuel must at least meet key ASTM specifications for jet fuel listed in ASTM specification D1655. Typical petroleum-based jet fuels consist primarily of straight chain alkanes, with C12 alkanes as the major component, and lesser amounts of aromatics and smaller and larger alkanes.

The term “diesel-range hydrocarbons” refers to any hydrocarbon or hydrocarbon mixture that distills in the range of about 160° C. to about 390° C., typically with a carbon number between about C11 and about C23, more preferably from C17-C23.

The term “diesel fuel” refers to a mixture typically comprising primarily hydrocarbon compounds that can be used to operate a diesel engine. In practical terms, the mixture of hydrocarbons called diesel fuel must meet key ASTM specifications for diesel fuel listed in ASTM specification D975. Typical petroleum-based diesel fuels consist of primarily linear alkanes with C14-C15 alkanes as the major-component, and lesser amounts of smaller and larger alkanes. Waxes are large molecular weight alkanes in the C23 hydrocarbon range.

The present process and system integrate methane pyrolysis with carbon dioxide conversion to economically produce low-carbon intensity fuels. Little if any CO₂ emissions result from the process.

The process comprises a first step of pyrolyzing methane to form a stream of hydrogen and solid carbon. The stream of hydrogen, low CI H₂, is then co-fed with a CO₂-containing stream to a fuel synthesis unit. In the unit, the CO₂ of the CO₂-containing stream and the hydrogen of the hydrogen stream are converted to a fuel. The fuel is generally a jet fuel or diesel fuel. A low CI naphtha (C5-C7) and a gas (C1-C4) can also be collected from the synthesis unit. The low-carbon intensity fuel product can also comprise methanol, ethanol, dimethyl ether, dimethoxymethane, oxymethylene ethers, higher alcohols, syngas or dimethyl carbonate. Any unreacted CO₂, H₂ as well as a portion of the low molecular weight gases C1-C4 can be recycled to further increase fuel production.

The synthesis unit can be any suitable synthesis unit for the conversion. Preferred examples include a Fischer-Tropsch synthesis unit, a direct CO₂ hydrogenation unit, a methanol synthesis unit alone or a methanol synthesis unit integrated with a methanol to gasoline unit. All of the foregoing units are well known to the industry.

In the methane pyrolysis, the methane can be pyrolyzed thermally or catalytically. When the pyrolysis is thermal, the heat can be provided to the pyrolysis process by a heat source selected from renewable electricity generated heat, nuclear generated heat, solar heat, or facility harvested heat or a steel manufacturing harvested heat.

The methane pyrolysis forms a stream of hydrogen and solid carbon. The stream of hydrogen is then co-fed with CO₂ to the synthesis unit. The stream of hydrogen can comprise all of the hydrogen fed to the synthesis unit, or it can be supplemented. The hydrogen steam may contain unconverted methane, which does not affect the CO₂ conversion unit. The solid carbon product is utilized as a fuel or sequestered to ensure it is not released into the atmosphere as CO₂. The solid carbon can also find potential applications for carbon black, fiber technology and nanotube production.

The CO₂-containing stream co-fed with the hydrogen to the synthesis unit can be obtained from a single source, or a combination of sources. One source is the flue gas from the methane pyrolysis. The combustion products include CO₂ and water. The CO₂ from the flue gas can be captured using a carbon capture system. This provides a source of CO₂ for the conversion reaction, but also prevents emitting CO₂ into the atmosphere. Preferably, there are no CO₂ emissions, all of the CO₂ is captured. Examples of carbon capture processes are amine scrubbing towers, an absorbent removal process and membrane separation units.

Another CO₂ source would be a CO₂-containing stream from an industrial source. Examples of such industrial sources include a hydrogen plant, a fluid catalytic cracking unit, a liquified natural gas (LNG) plant, or a coal-fired power plant. Such a source can be a sole source but is generally supplemental to the CO₂ captured from the flue gas.

Another source can be CO₂ obtained using a Direct Air Capture (DAC) system. CO₂ so captured from air can supplement the CO₂ removed from the flue gas CO₂ and/or the industrial source of CO₂. Direct air capture is best and most favorably employed at locations in which sufficient sources of CO₂ are unavailable or CO₂ is challenging to transport.

In another embodiment, provided is a system for producing low-carbon intensity fuels. The system comprises a pyrolizer for pyrolyzing methane. The pyrolizer has a methane inlet, and outlet for a stream of hydrogen, and an outlet for solid carbon. The outlet for a stream of hydrogen is also connected via a conduit to an inlet in a fuel synthesis unit. The inlet in the fuel synthesis unit can accommodate receiving the hydrogen stream and a CO₂ stream. The fuel synthesis unit also has an outlet for removing low-carbon intensity fuel.

The pyrolizer in the system can also include an outlet for a CO₂ containing flue gas and a carbon capture system in fluid communication with the outlet for the CO₂-containing flue gas. The carbon capture system separates at least a portion of the CO₂ from the flue gas stream and is passed through an outlet in the carbon capture system to the fuel synthesis unit.

The system can also include an additional CO₂ source to augment the CO₂ that is captured from the flue gas by the carbon capture system. This additional CO₂ source can include a direct air capture system, which can be part of the overall system.

The synthesis unit in the system can be specific to any suitable synthesis unit. However, examples include a Fischer-Tropsch synthesis unit, a direct CO₂ hydrogenation unit, a methanol synthesis unit alone or a methanol synthesis unit integrated with a methanol to gasoline unit. All of the foregoing units are well known to the industry.

Turning now to the Figures of the Drawing, various embodiments are illustrated, but are not meant to be limiting. It is understood the units, components, products and streams indicated by the same number in different figures are meant to indicate the same units, components, products, or streams.

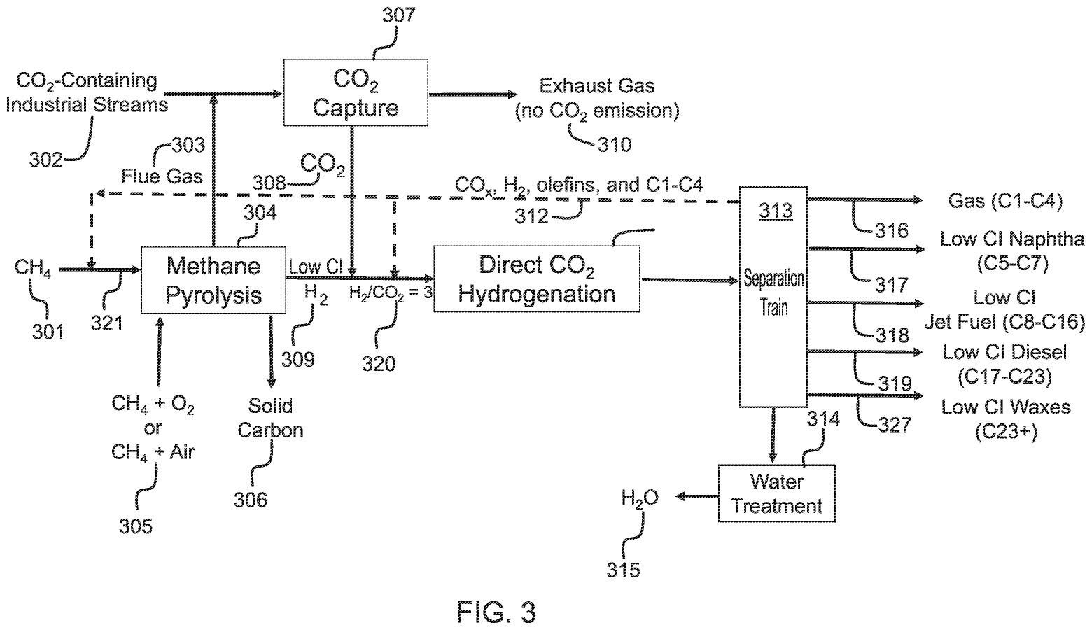

According to one embodiment, for which a process flow diagram is shown in FIG. 3, a feed of methane 301 is pyrolyzed in a pyrolizer 304 at a temperature of between about 800° C. and about 1000° C. to yield solid carbon 306 and low CI hydrogen 309. Pyrolysis is a process in which organic material is decomposed in an oxygen-lean atmosphere (i.e., significantly less oxygen than required for complete combustion). Alternatively, methane feed 301 can be catalytically decomposed with the use of a catalyst to form solid carbon 306 and low CI hydrogen 309. Methane and oxygen or methane and air, 305, can optionally be combusted to generate the heat necessary to achieve the pyrolysis temperatures. The combustion products are carbon dioxide and water (i.e., flue gas 303) that leave the pyrolizer and are combined with a CO₂-containing stream 302 from an industrial point source (e.g., a hydrogen plant, fluid catalytic cracking unit, cogeneration plant, and the like). A carbon capture system 307 can be utilized to avoid emitting CO₂ into the atmosphere, where all of the CO₂ is separated from the flue gas stream 303. An exhaust gas 310 with no CO₂ emission is released to the atmosphere. Examples of known carbon capture systems that can be used include, but are not limited to, amine scrubbing towers, adsorbent removal systems, and membrane separation units. In some embodiments, the heat source for the pyrolizer can be other than combustion, e.g., renewable electricity generated heat, nuclear generated heat, solar heat, or industrial facility-harvested heat, such as steel-manufacturing harvested heat. In such cases, the flue gas stream 303 will not be present and CO₂ will not be captured in capture system 307. The CO₂ source can then be a CO₂-containing industrial stream 302, such as one from a hydrogen plant, a FCC unit, LNG units, or coal-fired power plants. The CO₂ can also be previously captured and transported from another location.

Next, the low CI hydrogen 309 and CO₂ 308 stream are reacted with each other via a direct CO₂ hydrogenation system 311 to produce low CI fuels separated in separation train 313 into gas (C1-C4) 316, and liquid hydrocarbon fuels in the naphtha (C5-C7) 317, jet fuel (C8-C16) 318, diesel (C17-C23) 319 ranges, and/or waxes (C23⁺) 327.

The unreacted CO₂ , H₂, as well as a portion of the low molecular weight gases C1-C4, can be recycled in stream 312 to the direct CO₂ hydrogenation system 311 at 320 or to the methane pyrolizer 304 at 321 to increase the yield of fuel produced further.

As would be understood to one of ordinary skill in the art, water treatment unit 314 can be used to treat water 315 from the separation train 313 as needed before the water 315 is discharged to surface water sources or reused in other parts of the plant. Direct CO₂ hydrogenation wastewater can include various components such as alcohol, aldehyde, ketone, carboxylic acid, and inorganic compounds. Examples of wastewater treatment are well known in the art, including but not limited to distillation and/or steam stripping followed by an aerobic or anaerobic bio-treatment (e.g., as disclosed in L. Locatelli and G. Clerici, U.S. Pat. No. 7,989,510, 2011 and U. C. Onwusogh and K. S. Kathiar, Patent Publication No. WO2016193337A1). Other methods for purifying water include feeding a stream to a separation membrane, e.g., a ceramic membrane, and recovering water vapor from the downstream permeate side of the membrane (e.g., as disclosed in R. B. Pruet, U.S. Pat. No. 7,276,105).

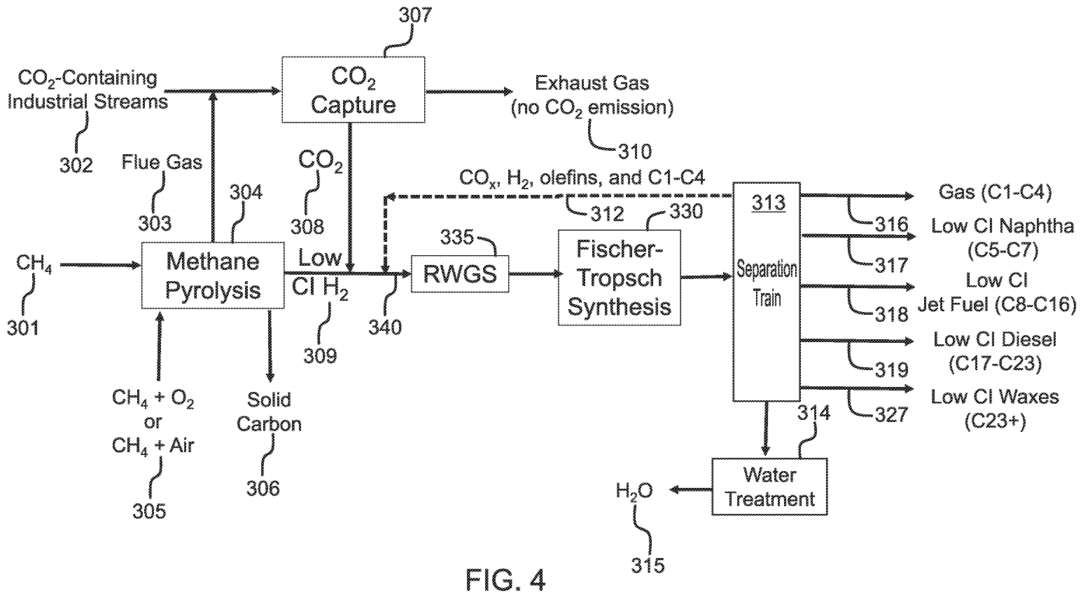

According to one embodiment, for which a process flow diagram is shown in FIG. 4, a feed of methane 301 is pyrolyzed in a pyrolizer 304 at a temperature of between about 800° C. and about 1000° C. to yield solid carbon 306 and low CI hydrogen 309. Pyrolysis is a process in which organic material is decomposed in an oxygen-lean atmosphere (i.e., significantly less oxygen than required for complete combustion). Also, pyrolysis can comprise a methane feed 301 which can be catalytically decomposed with the use of a catalyst to form solid carbon 306 and low CI hydrogen 309. Methane and oxygen or methane and air, 305, can optionally be combusted to generate the heat necessary to achieve the pyrolysis temperatures. The combustion products are carbon dioxide and water (i.e., flue gas 303) that leave the pyrolizer and are combined with a CO₂-containing stream 302 from an industrial point source (e.g., a hydrogen plant, fluid catalytic cracking unit, cogeneration plant, and the like). A carbon capture system 307 can be utilized to avoid emitting the CO₂ into the atmosphere, where all of the CO₂ is separated from the flue gas stream 303. An exhaust gas 310 with no CO₂ emission is released to the atmosphere. Examples of known carbon capture systems that can be used include, but are not limited to, amine scrubbing towers, adsorbent removal systems, and membrane separation units. In some embodiments, the heat source for the pyrolizer can be other than combustion, e.g., renewable electricity generated heat, nuclear generated heat, or industrial facility-harvested heat, such as steel-manufacturing harvested heat. In such cases, the flue gas stream 303 will not be present and CO₂ will not be captured in capture system 307. The CO₂ source can then be a CO₂-containing industrial stream 302, such as one from a hydrogen plant or a FCC unit. The CO₂ can also be previously captured and transported from another location.

Next, the low CI hydrogen 309 and CO₂ 308 stream are reacted with each other via Fischer-Tropsch synthesis 330 to produce low CI fuels separated in separation train 313 into gas (C1-C4) 316, and liquid hydrocarbon fuels in the naphtha (C5-C7) 317, jet fuel (C8-C16) 318, diesel (C17-C23) 319 ranges, and/or waxes (C23⁺) 327.

Fischer-Tropsch synthesis is a well-established technology for producing liquid and gaseous hydrocarbon fuels (such as gasoline, diesel, and gas oil) by passing a mixture of carbon monoxide and hydrogen referred to as synthesis gas or syngas having a H₂/CO molar ratio from 1 to 3 over iron-or cobalt-containing catalysts at elevated temperatures (e.g., 200-300° C.) and higher pressures (e.g., 50-100 psi). This process 335 involves the production of syngas via the catalytic reverse of the water-gas-shift reaction, also referred to as reverse water-gas-shift or RWGS 335, using CO₂ and H₂O feeds. The latter process is also a well-known technology with several licensors worldwide, including Topsoe and Mitsubishi. Technology is also available for an alternative process which does not make wax. See, for example, U.S. Pat. Nos. 7,943,674; 7,973,086; 8,519,011; or U.S. Patent Application No. 2014/0336286; all of which are incorporated herein in their entirety by reference.

Direct CO₂ hydrogenation has been developed during the last 10 years, by, for instance, OXCCU Tech Limited (Oxfordshire, UK) and Air Company (New York, USA). The process can form liquid and gaseous hydrocarbon fuels (such as gasoline, diesel, and gasoil) by reacting CO₂ and hydrogen feeds directly without the need for syngas generation. The process can form a gaseous stream, liquid hydrocarbons, and water. The low CI fuel formed can include at least one fuel selected from hydrocarbons in the gasoline, diesel, jet, naphtha and/or kerosene range, methanol, ethanol, dimethyl ether, dimethoxymethane, oxymethylene ethers, higher alcohol, syngas, and dimethyl carbonate.

The unreacted CO₂, H₂, as well as a portion of the low molecular weight gases C1-C4, can be recycled in stream 312 to the Fischer-Tropsch synthesis at 340.

As would be understood to one of ordinary skill in the art, water treatment unit 314 can be used to treat water 315 from the separation train 313 as needed before the water 315 is discharged to surface water sources or reused in other parts of the plant. Fischer-Tropsch wastewater can include various components such as alcohol, aldehyde, ketone, carboxylic acid, and inorganic compounds. Examples of wastewater treatment are well known in the art, including but not limited to distillation and/or steam stripping followed by an aerobic or anaerobic bio-treatment (e.g., as disclosed in L. Locatelli and G. Clerici, U.S. Pat. No. 7,989,510, 2011 and U. C. Onwusogh and K. S. Kathiar, Patent Publication No. WO2016193337A1). Other methods for purifying water include feeding a stream to a separation membrane, e.g., a ceramic membrane, and recovering water vapor from the downstream permeate side of the membrane (e.g., as disclosed in R. B. Pruet, U.S. Pat. No. 7,276,105).

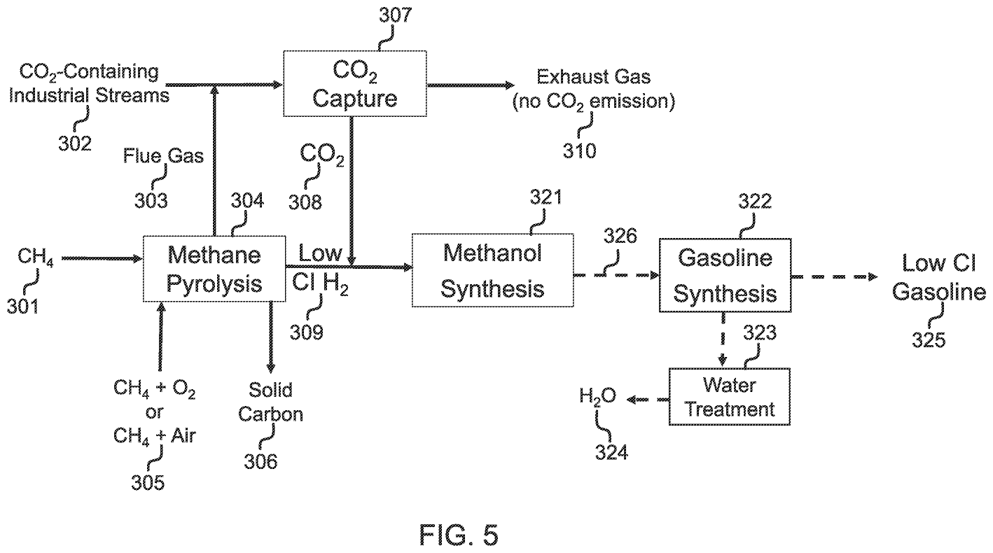

According to another embodiment, for which a process flow diagram is shown in FIG. 5, CH₄ pyrolysis and optional CO₂ capture are integrated as described above and shown in FIGS. 3 and 4, however the process is modified to make low CI methanol (MeOH) 326. CO₂ 308 and low CI H₂ 309 are transformed into methanol 326 using a commercially available MeOH synthesis system 321. Methanol synthesis from syngas was disclosed by BASF using Zn—Cr-Oxide catalysts (at a pressure of 250-350 atm and a temperature of 320-450° C.). Methanol synthesis from syngas was disclosed by ICI and Lurgi using a Cu—Zn—Al₂O₃ catalyst (at a pressure of 50-100 atm and a temperature of 210-270° C.) which is currently practiced commercially. Sustainable methanol synthesis from CO₂ and H₂ has been extensively studied in the last two decades. When CO₂ is present, the copper surface is covered by adsorbed oxygen, generating methanol via a reaction scheme involving adsorbed formate and methoxy intermediates. Several CO₂-to-methanol pilot or demonstration plants have been built. BSE uses electricity from a wind power plant to feed an electrolyzer unit to produce green hydrogen. Then, it utilizes CO₂ from a suitable source and H₂ to generate 163 tons/day of methanol at 40 bar and 240° C. Other methanol synthesis developments have been reported by Toyo Engineering, Topsoe A/S, and Mitsubishi Corporation.

The MeOH produced can be sold as is as a product into many applications. In one embodiment, commercially available methanol to gasoline (MTG) system 322 is optionally used to further convert the MeOH to low CI gasoline 325. MTG technology developed by Mobil Oil was demonstrated during the 1980s. In this process, methanol is vaporized and preheated, and partially dehydrated to form dimethyl ether (DME), an intermediate gas. The partially converted gas is then sent to the MTG reactors in 322 filled with ZSM-5 zeolite catalyst. To maintain a continuous operation, multiple parallel MTG reactors can be installed to allow for the regeneration of the MTG zeolite catalyst. Haldor Topsoe (now Topsoe A/S) developed the TIGAS (Topsoe Integrated Gasoline Synthesis) process. The MTG synthesis with MeOH synthesis is integrated in a single process loop. Water from the gasoline synthesis can be sent to water treatment 323 to produce clean water 324 that can be discharged to surface water sources or reused in other parts of the plant.

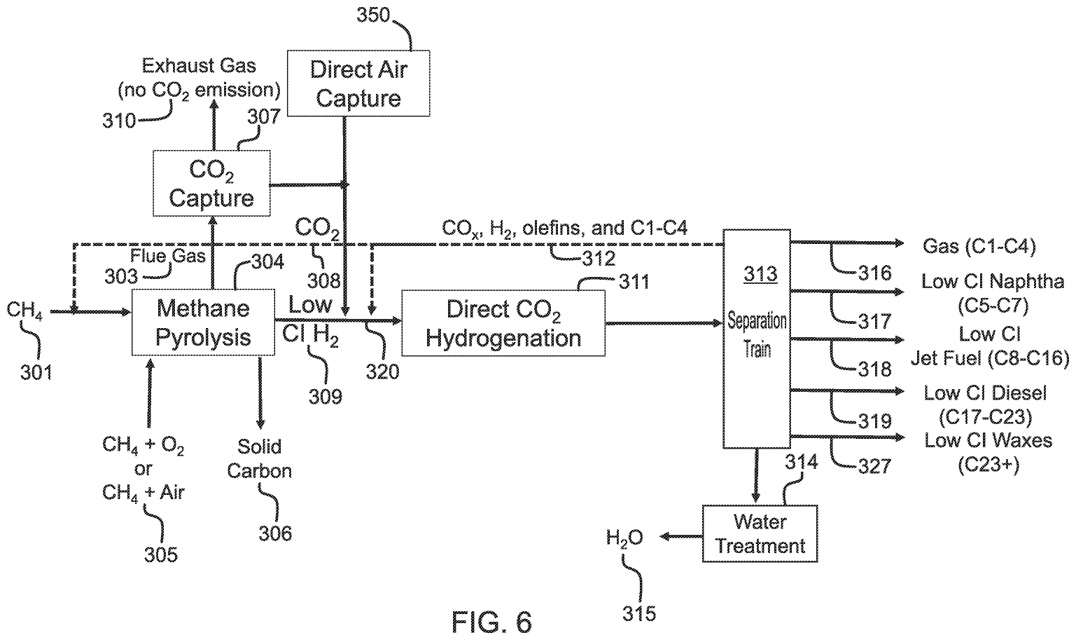

In FIG. 6, a process scheme similar to that in FIG. 3 is shown. The primary difference is that a Direct Air Capture (DAC) system 350 is employed as a supplemental source of CO₂. The CO₂ from the DAC 350 is combined with the CO₂ from the CO₂ capture unit 307 to make up the CO₂ 308 combined with the hydrogen 309 for feeding to the fuel synthesis unit 311.

An optional Direct Air Capture (DAC) system 350 which removes CO₂ directly from the air can be used as an additional CO₂ source. This may have advantages in locations in which point sources of CO₂ are unavailable, or CO₂ is challenging to transport. DAC technologies have been rapidly developing over the last twenty years. DAC is achieved when ambient air contacts a chemical media, typically an aqueous alkaline solvent or adsorbent which traps the carbon dioxide present. These chemical media are subsequently stripped of CO₂ through heating, resulting in a CO₂ stream that can undergo dehydration, compression, and further conversion, while simultaneously regenerating the chemical media for reuse. The alkaline solvents are usually amine-based or sodium or potassium hydroxides. Several solid adsorbents have been evaluated such as, but not limited to, sodium carbonate supported in alumina, amino-modified silica, anionic exchange polymer resin, and metal-organic frameworks. Recently membrane-based DAC technologies have been available.

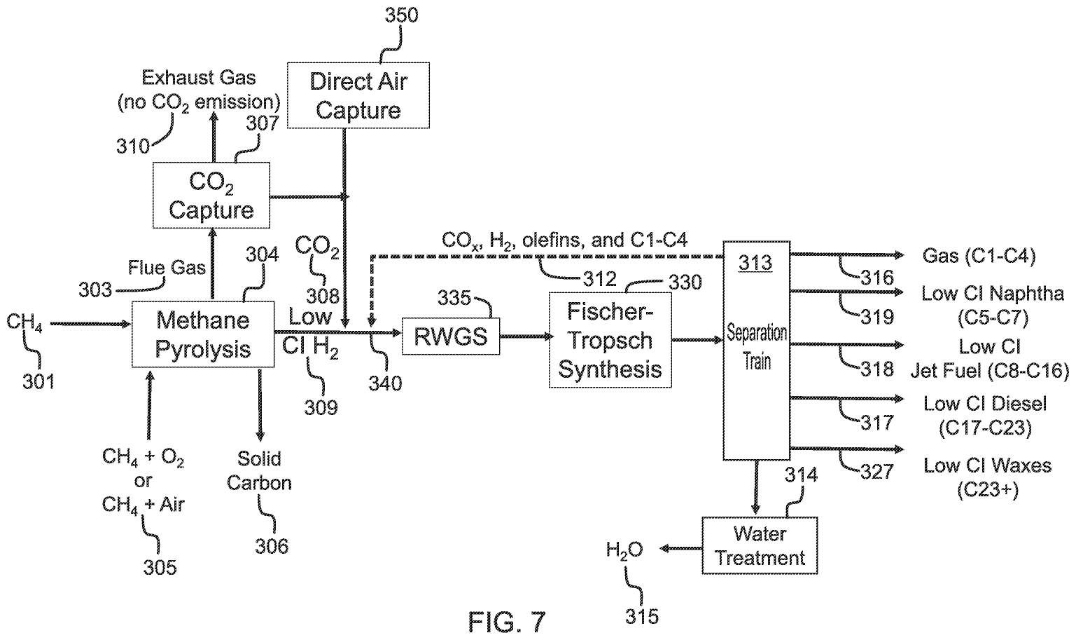

FIG. 7 depicts a process scheme similar to that depicted in FIG. 4, except with a Direct Air Capture (DAC) system 350 employed to provide CO₂ to the process and system. The CO₂ from the DAC 350 is combined with the CO₂ from the CO₂ capture unit 307 to make up the CO₂ 308 combined with the hydrogen 309 for feeding to the RWGS 335 and Fischer-Tropsch synthesis 330 units.

As shown in FIG. 4, in this embodiment, GHG emissions are avoided, and expensive electrolyzer and renewable energy are not required. Again, an optional Direct Air Capture (DAC) system which removes carbon dioxide directly from the air can be used as an additional CO₂ source.

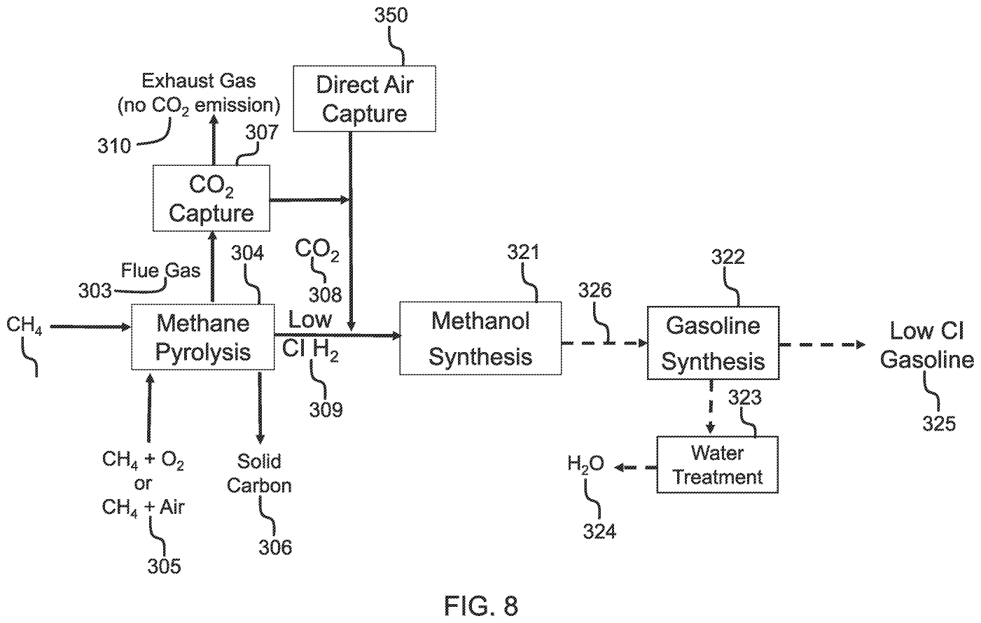

FIG. 8 depicts a process scheme similar to that depicted in FIG. 5, except with a Direct Air Capture (DAC) system 350 employed to provide CO₂ to the process and system. The CO₂ from the DAC 350 is combined with the CO₂ from the CO₂ capture unit 307 to make up the CO₂ 308 combined with the hydrogen 309 for feeding to the methanol synthesis unit 321.

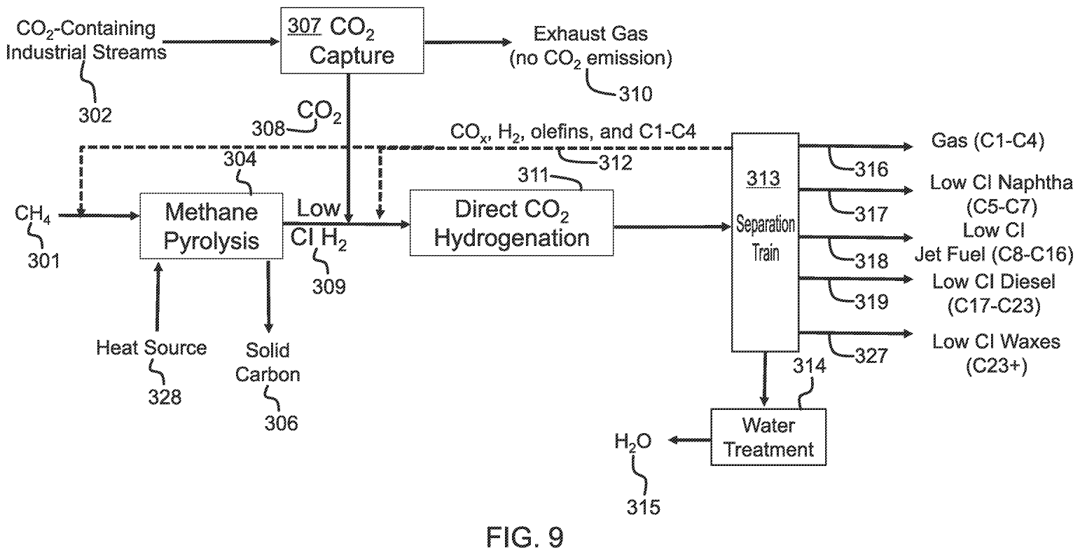

FIG. 9 depicts a process scheme similar to that of FIG. 3, except that only a CO₂-containing industrial stream is the source of CO₂. No flue gas is created. In the process depicted in FIG. 9, the heat source 328 for the pyrolizer is other than combustion. It can be, for example, renewable electricity generated heat, nuclear generated heat, solar heat, or industrial facility—harvested heat—such as steel-manufacturing harvested heat. The CO₂ from the industrial stream 302 can be captured in 307 to ensure any exhaust gas 310 has no CO₂ emission. The captured CO₂ 308 is then mixed with the hydrogen 309.

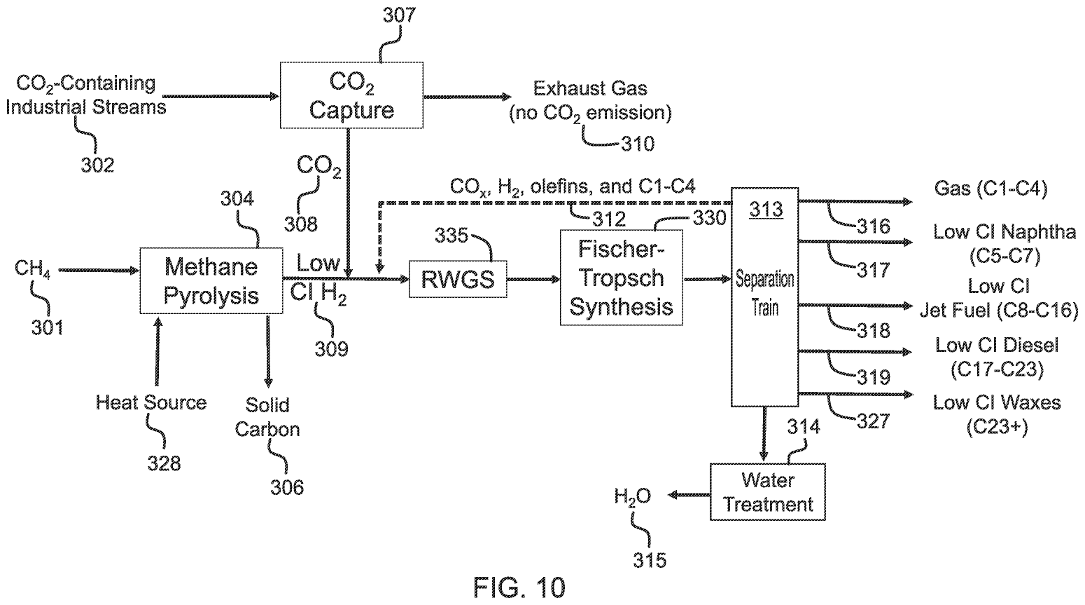

FIG. 10 depicts a process scheme similar to that of FIG. 4, except that only a CO₂-containing industrial stream is the source of CO₂. No flue gas is created. In the process depicted in FIG. 10, the heat source 328 for the pyrolizer is other than combustion. It can be, for example, renewable electricity generated heat, nuclear generated heat, solar heat, or industrial facility—harvested heat—such as steel-manufacturing harvested heat. The CO₂ from the industrial stream 302 can be captured in 307 to ensure any exhaust gas 310 has no CO₂ emission. The captured CO₂ 308 is then mixed with the hydrogen 309 and passed on to the RWGS 335 and the Fischer-Tropsch synthesis unit 330.

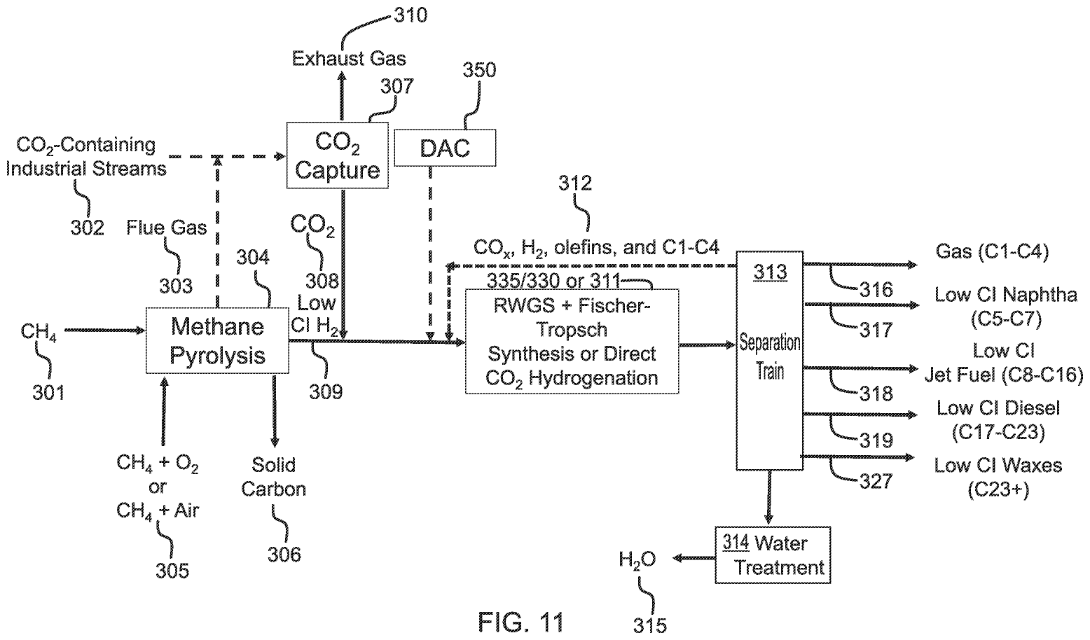

FIG. 11 depicts a process scheme similar to that of FIG. 4 and FIG. 7, except that multiple sources of CO₂ are used/available. The CO₂ from the CO₂ capture unit 307 is combined from the CO₂-containing industrial stream to provide the CO₂ 308, which is combined with the H₂ 309. CO₂ provided by a DAC 350 is subsequently added in the Figure, but could also be mixed in with the CO₂ from 302 and 307 to provide the CO₂ 308.

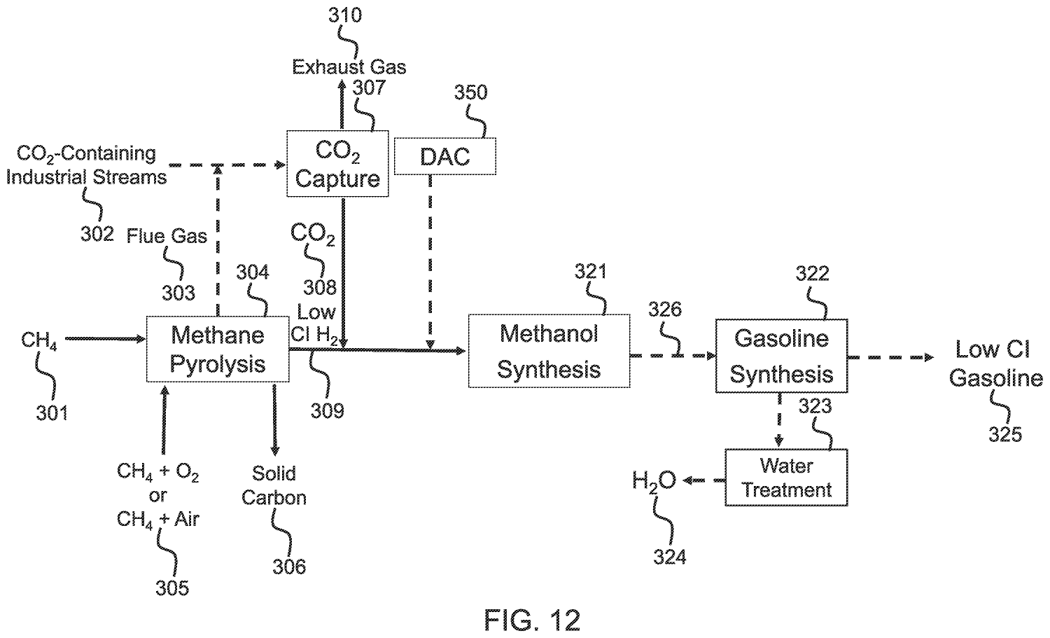

FIG. 12 depicts a process scheme similar to that of FIG. 5, except multiple sources of CO₂ are available, as also shown in FIG. 11.

In some embodiments, all of the hydrogen that is co-fed to the fuel synthesis unit is generated by the pyrolizer.

In some embodiments, the methane 301 used as the feedstock for the pyrolysis process can be low CI, renewable natural gas (RNG) produced from anaerobic digestion of biomass sources, including RNG from animal manure, wastewater, landfill gas, agricultural waste, and the like. During anaerobic digestion, plant or animal matter is broken down by microbial action in the absence of air to produce a gas with a high methane content. The plant or animal matter decomposition is via hydrolysis followed by the conversion of the decomposed matter to organic acids. Finally, the acids are converted to methane gas. Process temperature affects the rate of digestion and should be maintained in the mesophilic range (e.g., 35-41° C.). The CI of methane-containing gases made in these embodiments can be reduced or even become negative.

The present process successfully integrates methane pyrolysis, carbon capture and carbon dioxide conversion processes without the use of costly electrolyzers or renewable energy. The invention integrates a low CI hydrogen source that does not rely on, e.g., solar or wind power, and can be practiced at large scale. In addition, the invention can avoid GHG emissions and, at the same time, generate high-value, low CI products creating economic incentives. The solid carbon product 306 can optionally be utilized or sequestered, and may have potential applications in e.g., carbon black, carbon fiber, and carbon nanotube production. The process economics of the invention are further advantaged when a large-scale source of natural gas is fed to the pyrolizer 304.

The above-described embodiments are meant to illustrate and not to limit the invention, and other process schemes within the scope of the invention may be envisioned.

The following examples are provided to further illustrate the present processes, but are not meant to be limiting.

### EXAMPLES

### Example 1: Methane Pyrolysis

The thermal pyrolysis and catalytic cracking of methane to form a stream of hydrogen and solid carbon have been reported by Muranov, Sanchez-Bastardo et al, Chen et al., Msheik et al., and Naikoo et al. (see references below). The experiments are done by using a hydrocarbon metering and delivery sub-system, a downflow reactor, and an analytical sub-system. The runs are conducted at atmospheric pressure with hydrocarbon flow rates from 5 ml/min to 2 L/min (depending on the material and size of the reactor). The reactors (volume from 5 ml to 60 ml) are made from fused quartz or ceramic (alumina) to reduce the effect of the reactor material on the rate of hydrocarbon decomposition. The thermal experiments (no catalysts present) are performed in the 800-1200° C. temperature range.

Muranov, N., Hydrogen via methane decomposition: an application for decarbonization of fossil fuels, Int. J. of Hyd. Ener. pp. 1165-1175, 2001.

Sánchez-Bastardo, N., Schlögl, R., Ruland, H., Ind. Eng. Chem. Res. 2021, 60, pp. 11855-11881. https://doi.org/10.1021/acs.iecr.1c01679

Chen, L., Qi, Z., Zhang, S., Su, J., Somorjai, G. A., Catalytic Hydrogen Production from Methane:A Review on Recent Progress and Prospect, Catalysts 2020, 10, p. 858; doi:10.3390/cata110080858

Msheik, M., Rodat, Abanades, S., Methane Cracking for Hydrogen Production: A Review of Catalytic and Molten Media Pyrolysis. Energies, MDPI, 2021, p. 14, doi: 10.3390/en14113107.

Naikoo, G. A., Arshad F., Hassan I. U., Tabook, M. A., Pedram, M. Z., Mustaqeem, M., Tabassum, H., Ahmed, W, Rezakazemi M Thermocatalytic Hydrogen Production Through Decomposition of Methane—A Review. Front. Chem. 9:73680, 2021. doi:10.3389/fchem.2021.736801.

For the catalytic runs, the amount of catalyst is varied in the 0.03-2.0 g range. The catalysts are composed of metal-containing materials from groups 5 to 12 of the periodic table. Carbon, silica, and alumina are generally used as supports. The reactor temperature (700-900° C.) is maintained at a constant temperature via a thermocouple and a computer-controlled electric heater. In some cases, a fluidized bed reactor can be utilized to control the amount of carbon deposited and facilitated catalyst separation. Gaseous products of hydrocarbon decomposition are passed through a ceramic filter for the separation of airborne carbon particles and aerosols and analyzed via gas chromatography.

### Example 2: Direct CO₂ Hydrogenation

Iron-containing catalysts were prepared using the co-precipitation method following the method published in the literature (Davis, B H. TECHNOLOGY DEVELOPMENT FOR IRON FISCHER-TROPSCH CATALYSTS. United States: N. p., 1998. Web. doi:10.2172/8961. https://doi.org/10.2172/8961) Ammonium hydroxide was used as a precipitant agent, and a solution of iron nitrate nonahydrate was utilized as a source of Fe. The precipitation was carried out at 80° C. and a pH of ˜9.5. The obtained slurry was filtered, and the solids were washed several times with deionized water and then dried at 110° C. overnight. The final Fe-containing catalysts were obtained by impregnating them with the desired amount of potassium nitrate aqueous solution to obtain a 1 wt. %. of K. Tetraethylorthosilicate and alumina nitrate nonahydrate were used as the source of silicon and aluminum, respectively. Whereas copper, zinc, and manganese nitrate solutions were used as Cu, Zn, and Mn sources, respectively.

The direct CO₂ hydrogenation was evaluated in a down-flow micro-fixed reactor with a dimension of 1 cm I.D. and 60 cm of length. This system is equipped with mass flow controllers to provide separate flows at the desired rates for CO₂, H₂, and N₂. The gases were premixed in a small vessel (˜10 mL) before entering the reactor. The mixed gases entered the fixed bed reactor and passed through the catalyst bed with a size of 50-400 mesh. 3-5 g of Fe-catalyst were diluted with SiC (catalyst: SiC=1:2 m/m) and loaded into the fixed bed reactor.

The catalytic procedure was as follows. Firstly, the Fe-containing catalysts were activated in situ under H₂/N₂ (1/4) at 420° C. for six h before the CO₂ hydrogenation reaction started. The catalysts were tested at 270-330° C., 1.5 MPa, H₂/CO₂=3, and 2-3 L/g-cat/h. The reaction products were passed through warm (100° C.) and cold traps (0° C.). The uncondensed stream was de-pressurized to atmospheric pressure using a backpressure regulator and sent to analysis using gas chromatography. The liquid and wax products condensed in warm and cold traps were separated into different fractions (oil, wax, and water) and analyzed by gas chromatography. Using this procedure, carbon dioxide conversions of ˜40% with C₅⁺ hydrocarbon selectivity in the 50-60% were obtained. In the later fraction, the selectivities to naphtha, jet, and diesel were 19%, 53%, and 28, respectively. No waxes were detected.

### Example 3: Process Integration

The numerical process simulation of the integrated direct CO₂ hydrogenation with methane pyrolysis and CO₂ capture was carried out using the commercial software Aveva Pro/II 2020, 64 bit. The product distribution was calculated by the Anderson-Schultz-Flory method using a value of α=0.9 as reported by Fazeli et al. (J. Nat. Gas Sci. Eng. 52 (2018) pp. 549-558).

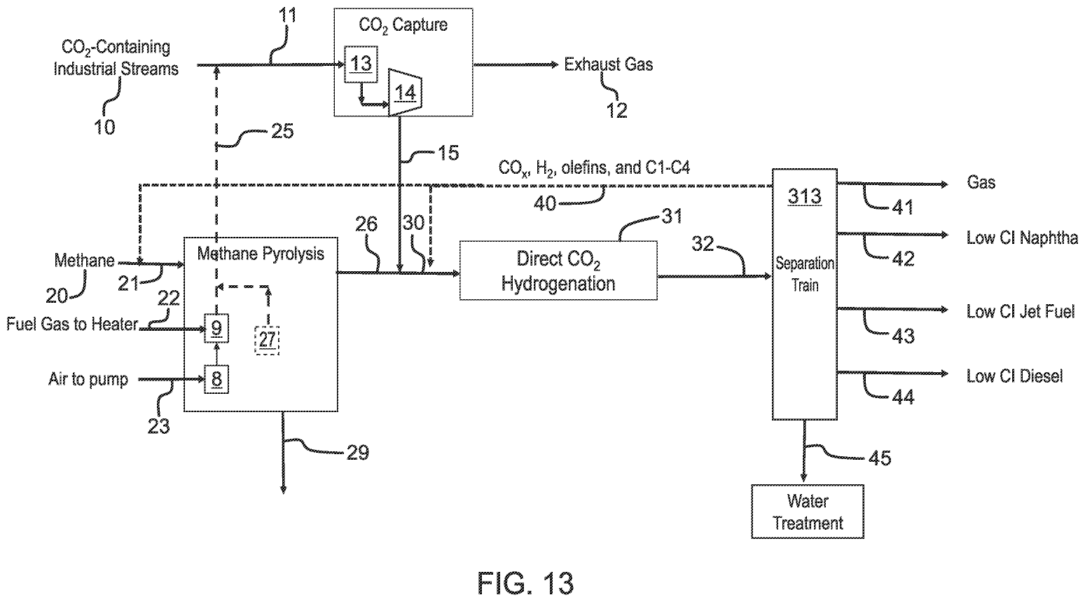

One embodiment of an overall integrated process is shown in FIG. 13. As seen, the methane pyrolysis unit uses methane feed 20 to generate hydrogen 26 and solid carbon 27. Some of this carbon is burned with air 23 supplied to an air pump 8 to heat the unit to 500-1000° C., using fuel gas 22 supplied to a heater 9. The non-burned carbon 29 is sold in the market. The CO₂ produced during carbon oxidation is sent to the CO₂ capture unit via 25, and, jointly with the industrial exhaust gas 10, is dehydrated 13 and compressed 14. The resulting carbon dioxide 15 is mixed with the H₂ 26 and fed to the direct CO₂ hydrogenation reactor 31. Finally, the products from the latter unit 32 are separated into gas 41, low CI naphtha 42, low CI jet fuel 43, low CI diesel 44, and water 45.

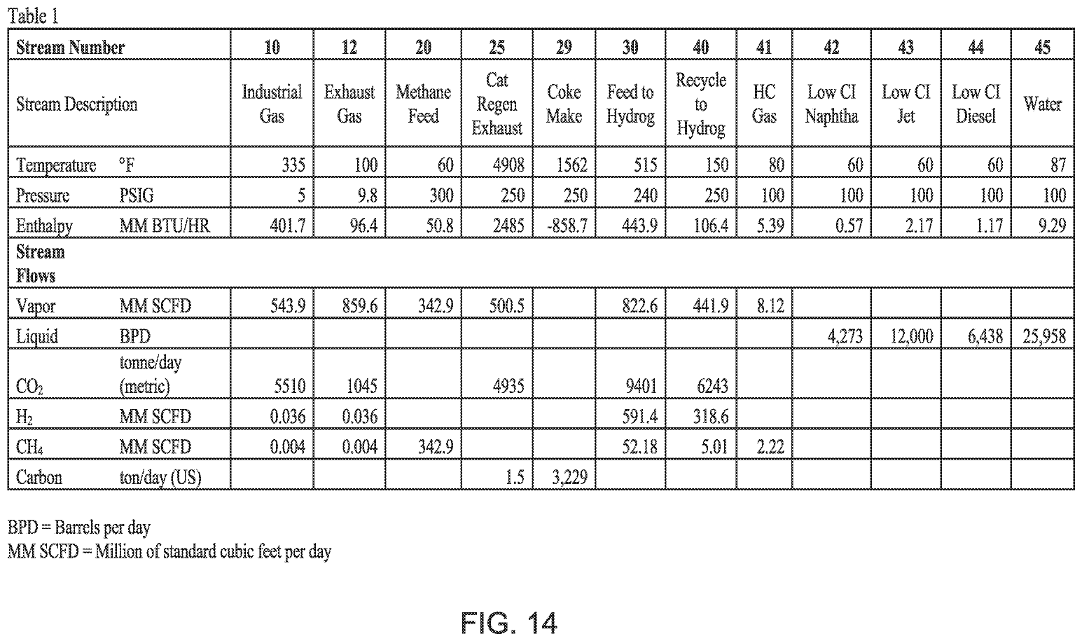

Table 1 in FIG. 14 shows the stream properties (temperatures, pressures, and enthalpy) and vapor, liquid, and solid compositions obtained from the numerical simulation of the integrated direct CO₂ hydrogenation with methane pyrolysis and CO₂ capture as shown in FIG. 13. As seen, to produce 12,000 barrels per day (BPD) of low CI jet fuel 43 in FIG. 13, 6,438 BPD of low CI diesel 44 and 4,273 MBD of low CI naphtha 42 were numerically calculated. Based on the numerical simulation, this process required 342 million standard cubic feet per day (MM SCFD) of methane 20 to generate 592 MM SCFD of hydrogen 26 and 3,229 ton/day of solid carbon 29. Also, the process simulated in FIG. 13 recycled 4,464 tonnes/day of CO₂ as calculated by subtracting the 5,510 tonnes/day of CO₂ feed 10 minus the 1,045 tonnes/day CO₂exhaust 12.

A numerical simulation of the integrated process showed that energy integration could be effectively obtained since the CH₄-pyrolysis and CO₂-capture reactions are endothermic, whereas the CO₂ hydrogenation process is exothermic. Furthermore, the simulation showed that the integrated scheme captures the CO₂ emissions from the methane pyrolysis 25 and allows the recycling of methane and other lighter hydrocarbons produced during CO₂ conversion 40 to the front of the CH₄ pyrolysis unit. The integrated scheme (FIG. 13) reduces the number of dedicated separation units with concomitant CAPEX and OPEX savings. More efficient and economical CO₂ conversion processes can be developed utilizing the invention described herein.

### Example 4: Process Integration for Fischer-Tropsch Synthesis

As in Example 3, the numerical process simulation of the integrated Fischer-Tropsch Synthesis with methane pyrolysis and CO₂ capture was carried out using the commercial software Aveva Pro/II 2020, 64 bit.

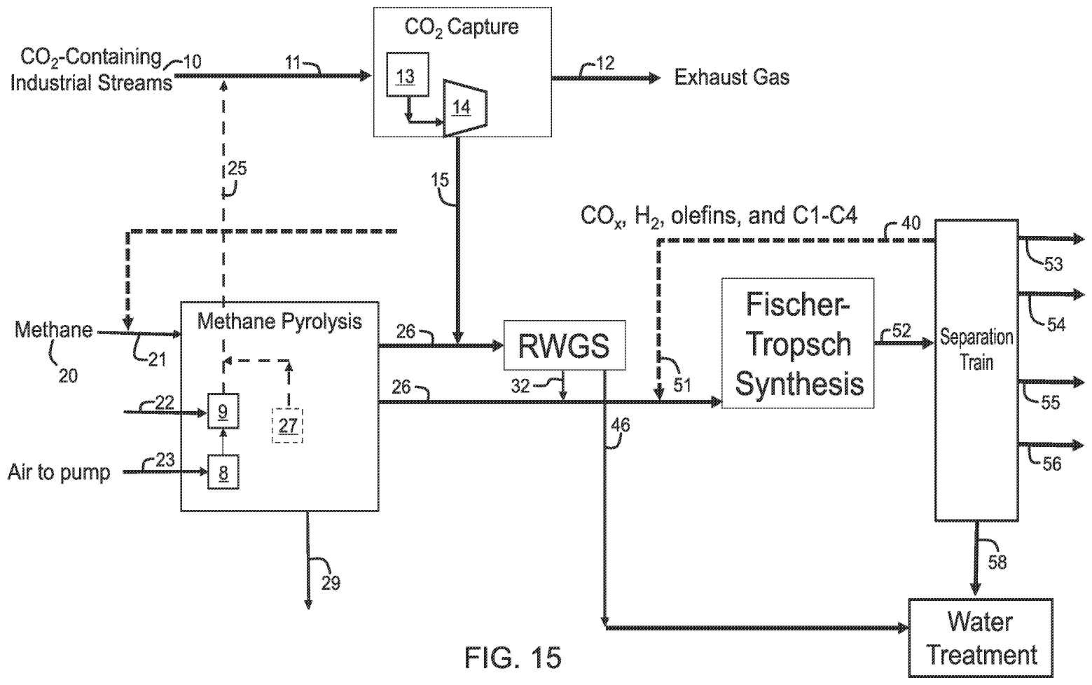

One embodiment of an overall integrated process is shown in FIG. 15, with the same numerals as in FIG. 13 respectively the same streams. As in example 3, the methane pyrolysis unit uses methane feed 20 to generate hydrogen 26 and solid carbon 27. Some of this carbon is burned with air 23 to heat the unit to 500-1000° C. The non-burned carbon 29 is sold in the market. The CO₂ produced during carbon oxidation 25 is sent to the CO₂ capture unit, and, jointly with the industrial exhaust gas 10, stream 11 is dehydrated 13 and compressed 14. The resulting carbon dioxide 15 is mixed with H₂ coming from the Methane Pyrolyzer 26 and sent to the Reverse Water Gas Shift (RWGS) reactor in which they are transformed into carbon monoxide 32 and water 46. The last stream 46 is sent to Water Treatment whereas the first 32 is mixed with additional hydrogen 26 to yield an H₂:CO stream with a molar ratio of 2, 51. This stream is fed to the Fischer-Tropsch Synthesis reactor. Finally, the products from the latter unit 52 are separated into gas 53, low CI naphtha 54, low CI jet fuel 55, low CI diesel 56, and water 58. No wax was created.

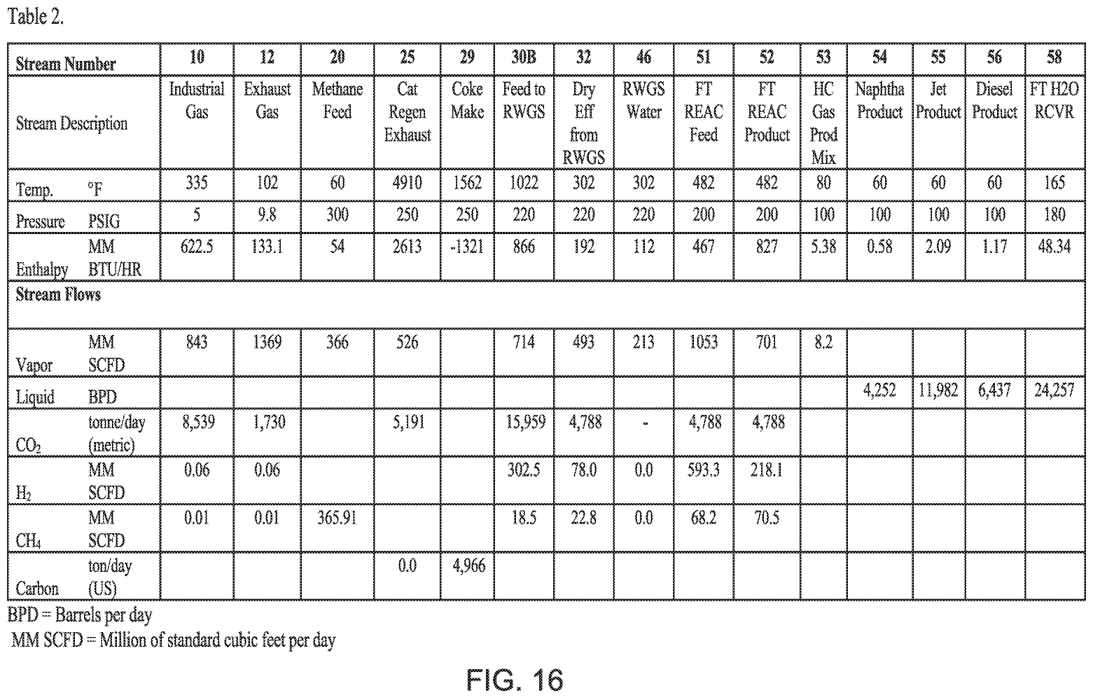

Table 2 in FIG. 16 shows the stream properties (temperatures, pressures, and enthalpy) and vapor, liquid, and solid compositions obtained from the numerical simulation of the integrated Fischer-Tropsch Synthesis with methane pyrolysis and CO₂ capture as shown in FIG. 15. As seen, to produce 11,982 barrels per day (BPD) of low CI jet fuel 55 in FIG. 15, 6,437 BPD of low CI diesel 56 and 4,252 MBD of low CI naphtha 54 were numerically calculated. Based on the numerical simulation, this process required 365 million standard cubic feet per day (MM SCFD) of methane 20 to generate 593 MM SCFD of hydrogen 51 and 4,966 ton/day of solid carbon 29. Also, the process simulated in FIG. 15 recycled 6,809 tonnes/day of CO₂ as calculated by subtracting the 8,539 tonnes/day of CO₂ feed 10 minus the 1,730 tonnes/day CO₂ exhaust 12.

A numerical simulation of the integrated process showed that energy integration could be effectively obtained since the CH₄-pyrolysis, the CO₂-capture, and the RWGS reactions are endothermic, whereas the Fischer-Tropsch Synthesis process is exothermic. Also, the simulation showed that the integrated scheme captures the CO₂ emissions from the methane pyrolysis 25 and allows the recycling of methane 40 and other lighter hydrocarbons produced during Fischer-Tropsch Synthesis to the front of the CH₄ pyrolysis unit. Thus, more efficient and economical CO₂ conversion processes can be developed utilizing the invention described herein.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements with the exception of only minor traces of impurities.

All patents and publications referenced herein are hereby incorporated by reference to the extent not inconsistent herewith. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present process and system, but they are not essential to its practice. It is therefore to be understood that the invention may be practiced otherwise than as specifically described without actually departing from the spirit and scope of the present invention as defined by the appended claims

What is claimed is:

1. A process for providing low-carbon intensity fuels comprising:
(a) pyrolyzing methane to form a stream of hydrogen and solid carbon; and
(b) co-feeding a CO₂-containing stream and the stream of hydrogen from (a) to a fuel synthesis unit in which the CO₂ of the CO₂-containing stream and the hydrogen of the stream of hydrogen are converted to a low-carbon intensity fuel.

2. The process of claim 1, wherein the CO₂-containing stream comprises CO₂ separated from a CO₂-containing flue gas stream formed by the pyrolysis of step (a).

3. The process of claim 2, further augmenting the CO₂-containing stream with CO₂ from an additional CO₂ source.

4. The process of claim 3, wherein the additional CO₂ source comprises CO₂ from a direct air capture system.

5. The process of claim 3, wherein the additional CO₂ source comprises CO₂ from a CO₂ containing industrial stream.

6. The process of claim 2, wherein all of the CO₂ is separated from the flue gas stream.

7. The process of claim 2, wherein the CO₂-containing stream is further augmented by CO₂ from a CO₂-containing industrial stream and/or CO₂ from a direct air capture system.

8. The process of claim 1, wherein the fuel synthesis unit is a Fischer-Tropsch synthesis unit integrated with a reverse water-gas-shift (RWGS) unit.

9. The process of claim 1, wherein the fuel synthesis unit is a direct CO₂ hydrogenation unit.

10. The process of claim 1, wherein the fuel synthesis unit is a methanol synthesis unit.

11. The process of claim 1, wherein the fuel synthesis unit is a methanol synthesis unit integrated with a methanol to gasoline unit.

12. The process of claim 1, wherein the methane is pyrolyzed thermally.

13. The process of claim 1, wherein the methane is pyrolyzed catalytically.

14. The process of claim 12, wherein heat is provided to the pyrolysis process by a heat source selected from renewable electricity generated heat, nuclear generated heat, facility-harvested heat, or steel manufacturing harvested heat.

15. The process of claim 1, further comprising separating a synthesized mixture formed in the fuel synthesis unit into a gaseous stream, liquid hydrocarbons, and water.

16. The process of claim 1, wherein the low-carbon intensity fuel includes at least one fuel selected from hydrocarbons in the gasoline, diesel, jet, naphtha, kerosene range, and/or wax range.

17. The process of claim 1, wherein the low-carbon intensity fuel comprises at least one fuel comprising methanol, ethanol, dimethyl ether, dimethoxymethane, oxymethylene ethers, higher alcohol, syngas, or dimethyl carbonate.

18. The process of claim 15, further comprising recycling at least a portion of the gaseous stream to the fuel synthesis unit.

19. The process of claim 1, wherein all of the hydrogen co-fed to the fuel synthesis unit is generated in step (a).

20. The process of claim 1, wherein no CO₂ is emitted by the process.

21. A system comprising:
a pyrolizer for pyrolyzing methane having a methane inlet, an outlet for a stream of hydrogen, and an outlet for solid carbon; and
a fuel synthesis unit with an inlet for receiving the stream of hydrogen and a CO₂-containing stream in which the CO₂ of the CO₂-containing stream and the hydrogen of the stream of hydrogen are converted to a low-carbon intensity fuel, with the fuel synthesis unit having an outlet for removing the low-carbon intensity fuel.

22. The system of claim 21, wherein the pyrolizer further includes an outlet for a CO₂-containing flue gas stream; wherein the system further includes a carbon capture system in fluid communication with the outlet for the CO₂-containing flue gas stream for separating at least a portion of the CO₂ from the flue gas stream; and wherein the separated CO₂ is fed to the fuel synthesis unit.

23. The system of claim 21, further including an additional CO₂ source to augment the CO₂ that the fuel synthesis unit can receive.

24. The system of claim 23, wherein the system comprises a direct air capture system as the additional CO₂ source.

25. The system of claim 22, wherein the carbon capture system is capable of separating all of the CO₂ from the flue gas stream.

26. The system of claim 21, wherein the fuel synthesis unit is a Fischer-Tropsch synthesis unit integrated with a RWGS unit.

27. The system of claim 21, wherein the fuel synthesis unit is a direct CO₂ hydrogenation unit.

28. The system of claim 21, wherein the fuel synthesis unit is a methanol synthesis unit.

29. The system of claim 21, wherein the fuel synthesis unit is a methanol synthesis unit integrated with a methanol to gasoline unit.

30. The system of claim 21, wherein the pyrolizer operates thermally.

31. The system of claim 21, wherein the pyrolizer includes catalysts and operates catalytically.

32. The system of claim 30, wherein the pyrolizer is heated by a heat source selected from renewable electricity generated heat, nuclear generated heat, facility-harvested heat, and steel manufacturing harvested heat.

33. The system of claim 21, further comprising a separation unit downstream of the fuel synthesis unit for separating a synthesized mixture into a gaseous stream, liquid hydrocarbons, and water.

34. The system of claim 21, wherein the system does not include an electrolyzer for generating hydrogen.
